(19) United States
(12) Patent Application Publication
(10) Pub. No.: US 2020/0236131 A1
(43) Pub. Date: Jul. 23, 2020

(54) PROTECTING ENDPOINTS WITH PATTERNS FROM ENCRYPTED TRAFFIC ANALYTICS

(71) Applicant: Cisco Technology, Inc., San Jose, CA (US)

(72) Inventors: Martin Vejman, Litomysl (CZ); Karel Bartos, Prague (CZ); Vitek Zlamal, Prague (CZ)

(21) Appl. No.: 16/251,322

(22) Filed: Jan. 18, 2019

(51) Int. Cl. H04L 29/06; H04L 12/24; H04L 12/26; G06N 3/04; G06N 3/08; G06N 20/00

(52) U.S. Cl. CPC H04L 63/1441; H04L 41/147; G06N 20/00; G06N 3/0445; G06N 3/08; H04L 43/04

(57) ABSTRACT

In one embodiment, an encrypted traffic analytics service captures telemetry data regarding encrypted network traffic associated with a first endpoint device in a network. The encrypted traffic analytics service receives, from the first endpoint device, an indication that a security agent executed on the first endpoint device has detected malware on the first endpoint device. The encrypted traffic analytics service constructs one or more patterns of encrypted traffic using the captured telemetry data from a time period associated with the received indication. The encrypted traffic analytics service uses the one or more patterns of encrypted traffic to detect malware on a second endpoint device by comparing the one or more patterns of encrypted traffic to telemetry data regarding encrypted network traffic associated with the second endpoint device.

### TECHNICAL FIELD

The present disclosure relates generally to computer networks, and, more particularly, to protecting endpoints with patterns from encrypted traffic analytics.

### BACKGROUND

Enterprise networks are carrying a very fast growing volume of both business and non-business critical traffic. Often, business applications such as video collaboration, cloud applications, etc., use the same hypertext transfer protocol (HTTP) and/or HTTP secure (HTTPS) techniques that are used by non-business critical web traffic.

Beyond the various types of legitimate application traffic in a network, some network traffic may also be malicious. For example, some traffic may seek to exfiltrate sensitive information from a network, such as credit card numbers, trade secrets, and the like. Further types of malicious network traffic include network traffic that propagate the malware itself and network traffic that passes control commands to already-infected devices, such as in the case of a distributed denial of service (DDoS) attack.

Inspection of network traffic is relatively straight-forward, when the network traffic is unencrypted. For example, techniques such as deep packet inspection (DPI), allows a networking device to inspect the payloads of packets and identify the contents of the packets. However, the use of traffic encryption is becoming increasingly ubiquitous and any instances of malware now use encryption, to conceal their network activity from detection. While it may be possible, in some cases, to detect malware by executing a security/malware-detection agent directly on an endpoint device, many endpoint devices today lack such agents for various reasons, such as a lack of resources.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates the capture of traffic telemetry data in a network;

FIG. 4 illustrates an example of the use of patterns of encrypted traffic to detect malware in a network;

FIG. 5 illustrates an example of matching patterns of encrypted traffic for malware detection;

FIGS. 6A-6B illustrate an example architecture for using a recurrent neural network to detect malware from patterns of encrypted traffic; and

FIG. 7 illustrates an example simplified procedure for using patterns of encrypted traffic to detect malware in a network.

### DESCRIPTION OF EXAMPLE EMBODIMENTS

### Overview

According to one or more embodiments of the disclosure, an encrypted traffic analytics service captures telemetry data regarding encrypted network traffic associated with a first endpoint device in a network. The encrypted traffic analytics service receives, from the first endpoint device, an indication that a security agent executed on the first endpoint device has detected malware on the first endpoint device. The encrypted traffic analytics service constructs one or more patterns of encrypted traffic using the captured telemetry data from a time period associated with the received indication. The encrypted traffic analytics service uses the one or more patterns of encrypted traffic to detect malware on a second endpoint device by comparing the one or more patterns of encrypted traffic to telemetry data regarding encrypted network traffic associated with the second endpoint device.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may further be interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless networks. That is, in addition to one or more sensors, each sensor device (node) in a sensor network may generally be equipped with a radio transceiver or other communication port, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

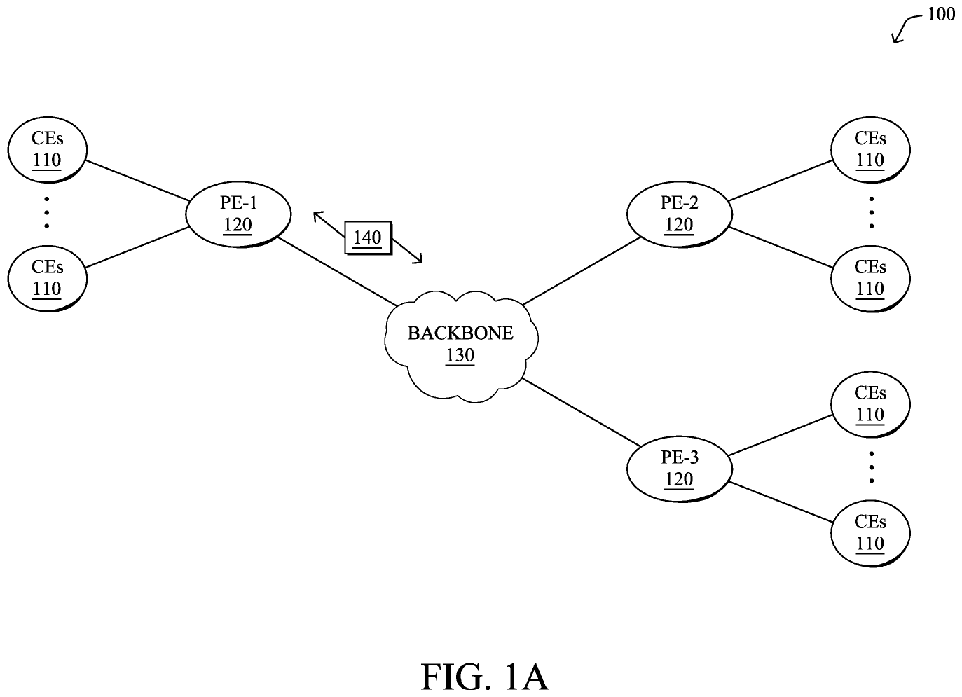

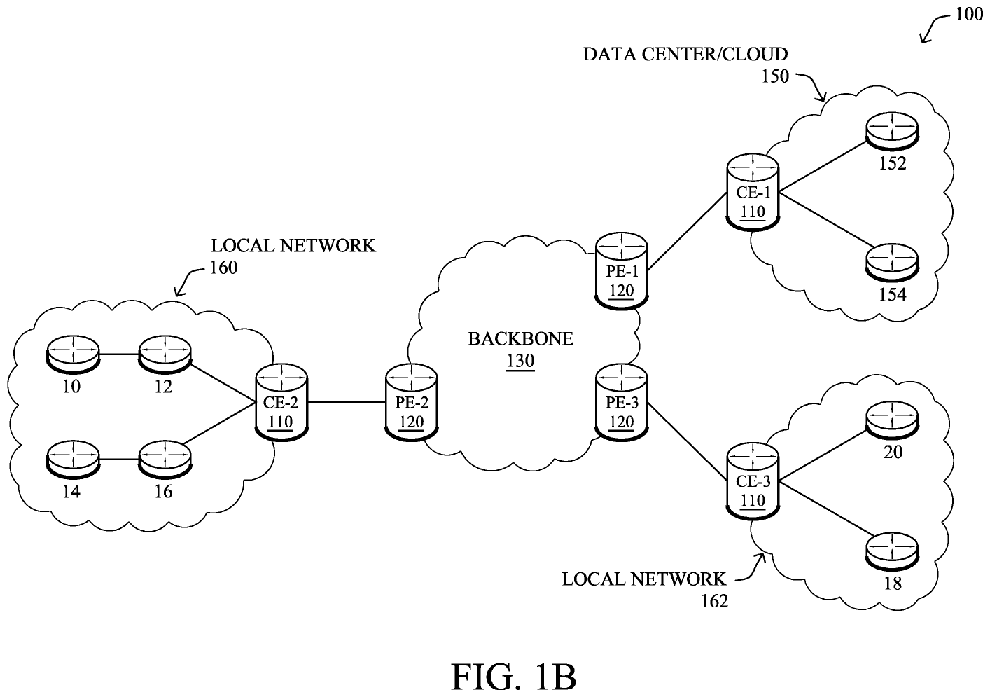

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN, thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different service providers), with potentially a backup link (e.g., a 3G/4G/LTE connection). A site of type B may itself be of different types:

2a.) Site Type B1: a site connected to the network using two MPLS VPN links (e.g., from different service providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

The techniques herein may also be applied to other network topologies and configurations. For example, the techniques herein may be applied to peering points with high-speed links, data centers, etc. Further, in various embodiments, network 100 may include one or more mesh networks, such as an Internet of Things network. Loosely, the term “Internet of Things” or “IoT” refers to uniquely identifiable objects/things and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless networks, etc., are often on what is referred to as Low-Power and Lossy Networks (LLNs), which are a class of network in which both the routers and their interconnect are constrained. In particular, LLN routers typically operate with highly constrained resources, e.g., processing power, memory, and/or energy (battery), and their interconnections are characterized by, illustratively, high loss rates, low data rates, and/or instability. LLNs are comprised of anything from a few dozen to thousands or even millions of LLN routers, and support point-to-point traffic (e.g., between devices inside the LLN), point-to-multipoint traffic (e.g., from a central control point such at the root node to a subset of devices inside the LLN), and multipoint-to-point traffic (e.g., from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

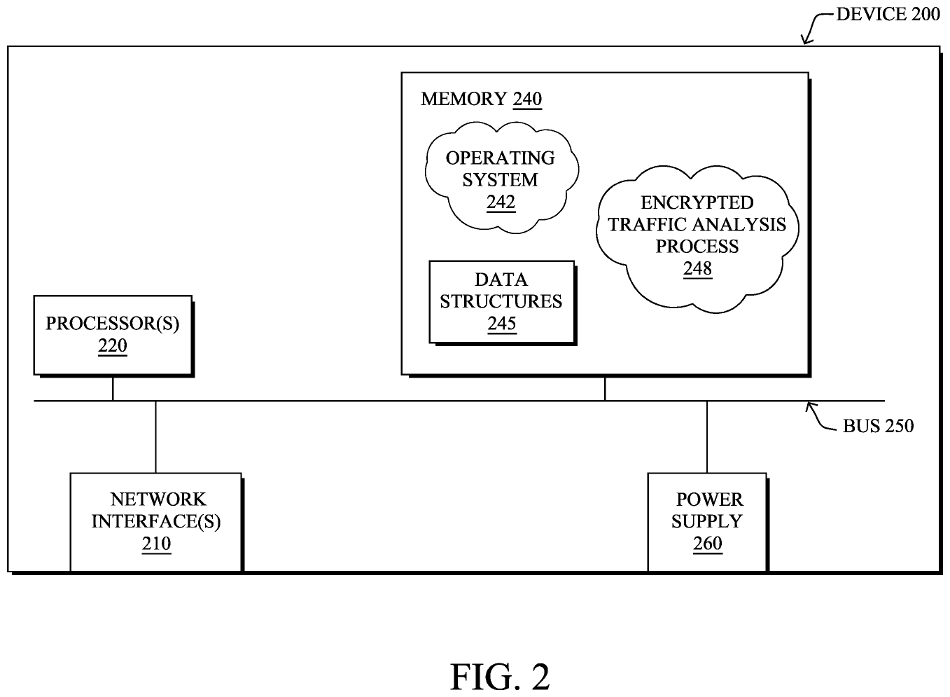

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an encrypted traffic analytics process 248.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, encrypted traffic analytics process 248 may execute one or more machine learning-based classifiers to classify encrypted traffic in the network (and its originating application) for any number of purposes. In one embodiment, encrypted traffic analytics process 248 may assess captured telemetry data regarding one or more traffic flows, to determine whether a given traffic flow or set of flows are caused by malware in the network, such as a particular family of malware applications. Example forms of traffic that can be caused by malware may include, but are not limited to, traffic flows reporting exfiltrated data to a remote entity, spyware or ransomware-related flows, command and control (C2) traffic that oversees the operation of the deployed malware, traffic that is part of a network attack, such as a zero day attack or denial of service (DoS) attack, combinations thereof, or the like. In further embodiments, encrypted traffic analytics process 248 may classify the gathered telemetry data to detect other anomalous behaviors (e.g., malfunctioning devices, misconfigured devices, etc.), traffic pattern changes (e.g., a group of hosts begin sending significantly more or less traffic), or the like.

Encrypted traffic analytics process 248 may employ any number of machine learning techniques, to classify the gathered telemetry data. In general, machine learning is concerned with the design and the development of techniques that receive empirical data as input (e.g., telemetry data regarding traffic in the network) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, encrypted traffic analytics process 248 can use the model M to classify new data points, such as information regarding new traffic flows in the network. Often, M is a statistical model, and the cost function is inversely proportional to the likelihood of M, given the input data.

In various embodiments, encrypted traffic analytics process 248 may employ one or more supervised, unsupervised, or semi-supervised machine learning models. Generally, supervised learning entails the use of a training set of data, as noted above, that is used to train the model to apply labels to the input data. For example, the training data may include sample telemetry data that is “normal,” or “malware-generated.” On the other end of the spectrum are unsupervised techniques that do not require a training set of labels. Notably, while a supervised learning model may look for previously seen attack patterns that have been labeled as such, an unsupervised model may instead look to whether there are sudden changes in the behavior of the network traffic. Semi-supervised learning models take a middle ground approach that uses a greatly reduced set of labeled training data.

Example machine learning techniques that encrypted traffic analytics process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of traffic flows that are incorrectly classified as malware-generated, anomalous, etc. Conversely, the false negatives of the model may refer to the number of traffic flows that the model incorrectly classifies as normal, when actually malware-generated, anomalous, etc. True negatives and positives may refer to the number of traffic flows that the model correctly classifies as normal or malware-generated, etc., respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

In some cases, encrypted traffic analytics process 248 may assess the captured telemetry data on a per-flow basis. In other embodiments, encrypted traffic analytics process 248 may assess telemetry data for a plurality of traffic flows based on any number of different conditions. For example, traffic flows may be grouped based on their sources, destinations, temporal characteristics (e.g., flows that occur around the same time, etc.), combinations thereof, or based on any other set of flow characteristics.

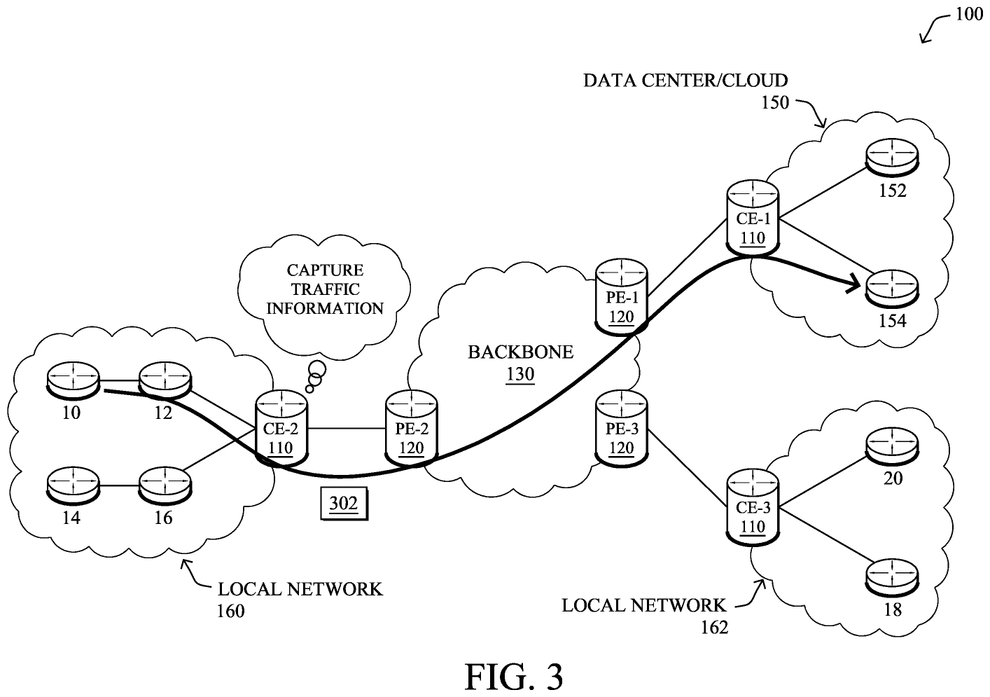

As shown in FIG. 3, various mechanisms can be leveraged to capture information about traffic in a network, such as telemetry data regarding a traffic flow. For example, consider the case in which client node 10 initiates a traffic flow with remote server 154 that includes any number of packets 302. Any number of networking devices along the path of the flow may analyze and assess packet 302, to capture telemetry data regarding the traffic flow. For example, as shown, consider the case of edge router CE-2 through which the traffic between node 10 and server 154 flows.

In some embodiments, a networking device may analyze packet headers, to capture feature information about the traffic flow. For example, router CE-2 may capture the source address and/or port of host node 10, the destination address and/or port of server 154, the protocol(s) used by packet 302, or other header information by analyzing the header of a packet 302. Example captured features may include, but are not limited to, Transport Layer Security (TLS) information (e.g., from a TLS handshake), such as the ciphersuite offered, user agent, TLS extensions (e.g., type of encryption used, the encryption key exchange mechanism, the encryption authentication type, etc.), HTTP information (e.g., URI, etc.), Domain Name System (DNS) information, or any other data features that can be extracted from the observed traffic flow(s).

In further embodiments, the device may also assess the payload of the packet to capture information about the traffic flow. For example, router CE-2 or another device may perform deep packet inspection (DPI) on one or more of packets 302, to assess the contents of the packet, provided the packet is unencrypted. Doing so may, for example, yield additional information that can be used to determine the application associated with the traffic flow (e.g., packets 302 were sent by a web browser of node 10, packets 302 were sent by a videoconferencing application, etc.). However, as would be appreciated, a traffic flow may also be encrypted, thus preventing the device from assessing the actual payload of the packet. In such cases, the characteristics of the application can instead be inferred from the captured header information.

The networking device that captures the flow telemetry data may also compute any number of statistics or metrics regarding the traffic flow. For example, CE-2 may determine the start time, end time, duration, packet size(s), the distribution of bytes within a flow, etc., associated with the traffic flow by observing packets 302. In further examples, the capturing device may capture sequence of packet lengths and time (SPLT) data regarding the traffic flow, sequence of application lengths and time (SALT) data regarding the traffic flow, or byte distribution (BD) data regarding the traffic flow.

As noted above, malware is increasingly using encryption to conceal its activities in a network, such as lateral movements in the network, data exfiltration, and the passing of command and control traffic to infected endpoint devices. This use of encryption makes it impossible to perform DPI on the encrypted packets. While some solutions provide for the decryption of all network traffic by an intermediary device that acts as a man-in-the-middle proxy, doing so may also be undesirable from a privacy standpoint or, at worst, illegal in some jurisdictions.

Another potential approach to combating malware is to execute a security agent, such as an anti-virus program, on each of the endpoint devices. However, doing so can be extremely cumbersome and expensive. In addition, IoT devices and other low-capability devices may not have the requisite resources to execute such agents. Accordingly, many network deployments today include both endpoint devices with locally-executed security agents and endpoint devices that do not.

Protecting Endpoints with Patterns from Encrypted Traffic Analytics

The techniques herein introduce a system that leverages encrypted traffic analytics to build behavioral patterns of encrypted network traffic associated with malicious/suspicious binaries that have been detected by endpoint security agents. Once created, these patterns can be used to detect the presence of harmful binaries in the parts of the network without any endpoint protection.

Specifically, according to one or more embodiments of the disclosure as described in detail below, an encrypted traffic analytics service captures telemetry data regarding encrypted network traffic associated with a first endpoint device in a network. The encrypted traffic analytics service receives, from the first endpoint device, an indication that a security agent executed on the first endpoint device has detected malware on the first endpoint device. The encrypted traffic analytics service constructs one or more patterns of encrypted traffic using the captured telemetry data from a time period associated with the received indication. The encrypted traffic analytics service uses the one or more patterns of encrypted traffic to detect malware on a second endpoint device by comparing the one or more patterns of encrypted traffic to telemetry data regarding encrypted network traffic associated with the second endpoint device.

Illustratively, the techniques described herein may be performed by hardware, software, and/or firmware, such as in accordance with the encrypted traffic analytics process 248, which may include computer executable instructions executed by the processor 220 (or independent processor of interfaces 210) to perform functions relating to the techniques described herein.

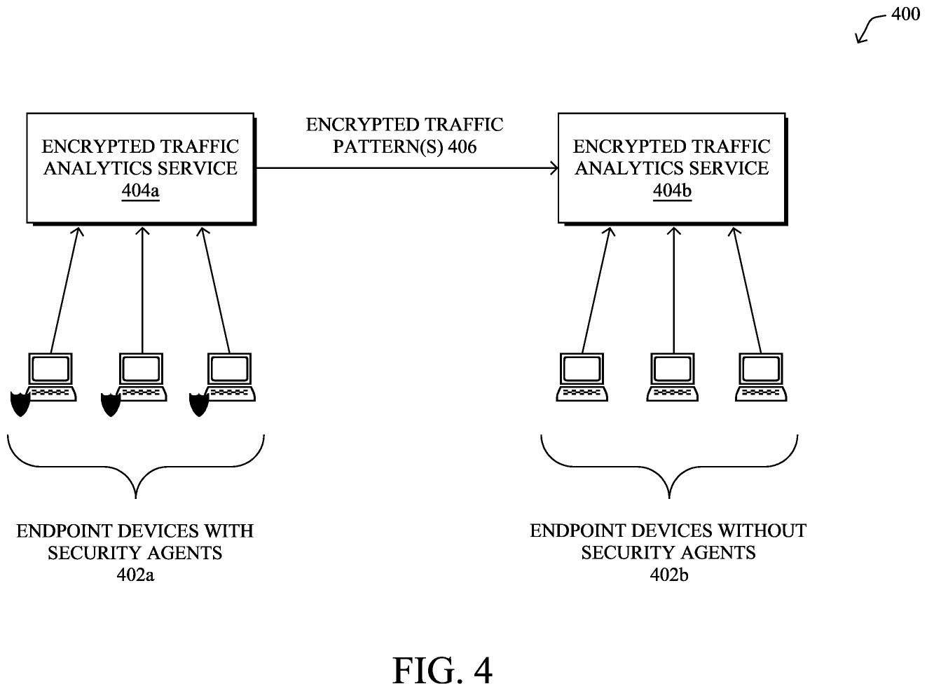

Operationally, FIG. 4 illustrates an example of the use of patterns of encrypted traffic to detect malware in a network, according to various embodiments. As shown, assume that a network 400 includes two groups of endpoint devices: 1.) a first group 402a of endpoint devices 402a on which security agents (e.g., anti-virus/malware detection agents) are executed to detect the presence of malware and 2.) a second group 402b of endpoint devices that do not execute such security agents. For example, group 402b may include IoT devices or other endpoint devices that lack the resources to execute security agents or are otherwise not configured for endpoint protection.

Also as shown may be a first component 404a of an encrypted traffic analytics service through which network traffic associated with group 402a flows (e.g., a device 200 executing encrypted traffic analytics process 248). A component 404b of the encrypted traffic analytics service may similarly be deployed as an intermediary in the network through which traffic associated with group 402b flows.

According to various embodiments, the proposed malware detection mechanism performs two primary functions:

1.) Collecting encrypted traffic patterns from harmful binaries: The encrypted traffic analytics service collects telemetry data regarding encrypted traffic patterns associated with harmful binaries (e.g., not associated with web browsing. In general, it is not possible, nor necessary, to keep a large history of network connections. Instead, patterns of encrypted traffic can be constructed from unique network connections associated with malicious binaries that occur within a limited time window. In one embodiment, each pattern of encrypted traffic may include a set of feature vectors representing the connections that occurred within the time window. This allows the service to work with a description of the traffic without having to store the full traffic captures in memory. Once generated, the patterns of encrypted traffic from the time period can be sent for use in the portions of the network that include endpoint devices without security agents.

2.) Detecting harmful binaries with the encrypted traffic patterns: The generated patterns of encrypted traffic can then be compared against the encrypted traffic associated with the unprotected endpoint devices in the network, to detect the presence of malware on these endpoints. For example, if a partial/significant overlap is found between the observed traffic and the pattern(s), the service may initiate the performance of a mitigation action, such as sending an alert to a user interface that describes the location of the threat, the type of threat, and/or a measure of confidence associated with the determination (e.g., based on the degree of overlap). In further cases, the service can outright block or otherwise quarantine traffic associated with the infected endpoint.

More specifically, assume that a security agent executed by one of the endpoint devices in group 402a detects the presence of a malicious file on that endpoint device. In such a case, the agent may notify component 404a of the encrypted traffic analytics service of the malware detection. In turn, the encrypted traffic analytics service may use captured telemetry data regarding the encrypted traffic of that endpoint device over a period of time to compute a set of feature vectors. This set of feature vectors serves as the pattern(s) 406 of encrypted traffic for the corresponding malicious file. As would be appreciated, the size of such a pattern depends on the number of flows/connections associated with the file and on the length of the time window (e.g., on the order of minutes). As noted above, each pattern may comprise telemetry features such as, but not limited to, the following: TLS extension(s), cipher suite(s), TLS version, SPLT information, and/or other features such as byte or packet counts (e.g., in the aggregate or in a single direction), or timing information. In further embodiments, flow-level telemetry data can also be used, such as by combining per-flow features using a bagging approach. For example, further data that can be used as part of a pattern may include the sum of bytes, number of flows, or number of unique TLS versions observed within the time windows, or the like.

In various embodiments, the encrypted traffic pattern(s) 406 constructed by the encrypted traffic analytics service can be stored locally within network 400. In other embodiments, however, pattern(s) 406 can be sent for storage in a global database in the cloud, so that they can be applied globally and not only in the specific network or environment in which they were observed.

As shown, the constructed one or more patterns 406 of encrypted traffic may be sent to component 404b of the encrypted traffic analytics service. In turn, component 404b may apply the pattern(s) 406 to the encrypted traffic associated with group 402b of endpoint devices that are not protected by endpoint security agents, to detect the presence of malware on any of the endpoint devices.

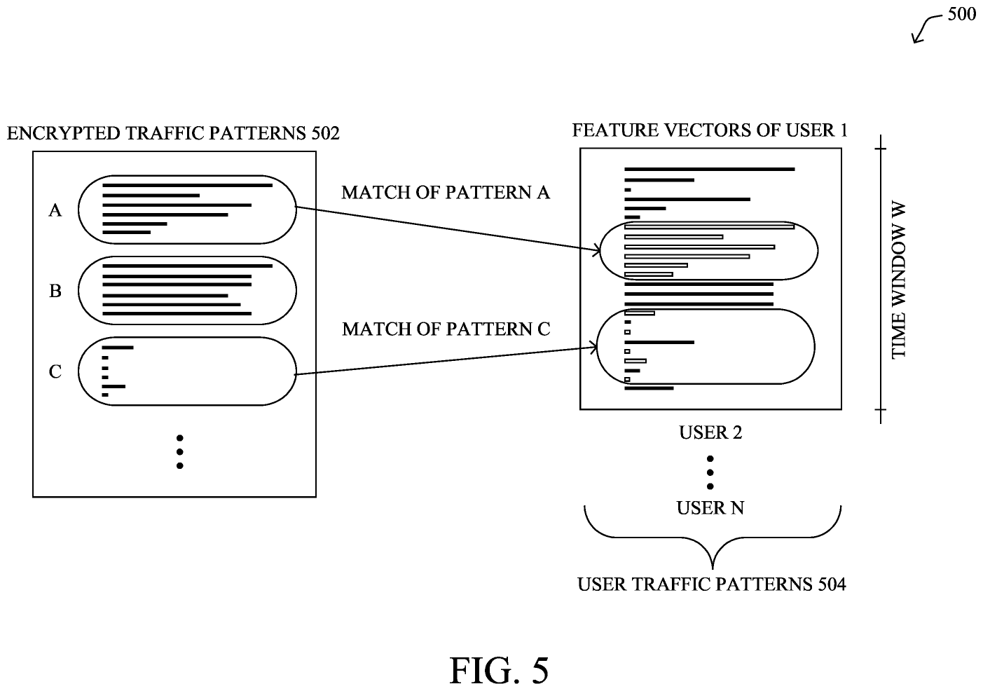

FIG. 5 illustrates an example 500 of matching patterns of encrypted traffic for malware detection, according to various embodiments. As shown, assume that encrypted traffic patterns 502 have been constructed by the encrypted traffic analytics service. To detect the presence of malware using patterns 502, the encrypted traffic analytics service may compare patterns 502 to traffic patterns 504 on a per-user or per-endpoint device basis. For example, as shown, the encrypted traffic analytics service may form user traffic patterns 504 as sets of feature vectors from the captured telemetry data for encrypted traffic associated with N-number of different users. In turn, the encrypted traffic analytics service may sort the feature vectors for each user (or endpoint device) by ending time of the flows and may be stored for a limited amount of time (e.g., for a time window W). Every period of time, such as every 1-5 minutes, encrypted traffic analytics service may compute the coverage of patterns 502 on the observed traffic patterns 504. This computation scales linearly with the number of patterns 502-504, the size of these patterns, and the number of user/endpoint devices in the network. In some embodiments, based on the comparison, the encrypted traffic analytics service may assign a score s to each user or endpoint device that represents a measure of confidence that the corresponding network traffic belongs to malicious binary file. Note also that a pattern 502 may match a pattern 504, even if there is not a complete match. For example, as shown, pattern C may match that of user 1, even if the traffic pattern of the user also includes some legitimate feature vectors in between and even if the order does not match exactly, depending on the metric that encrypted traffic analytics service uses to find the overlap (e.g., distance, etc.).

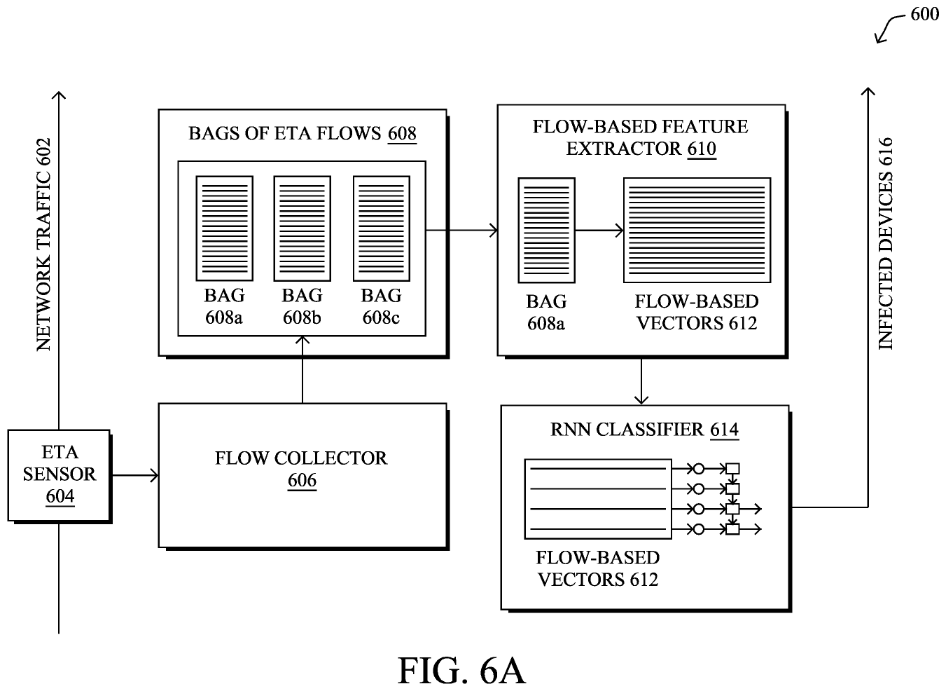

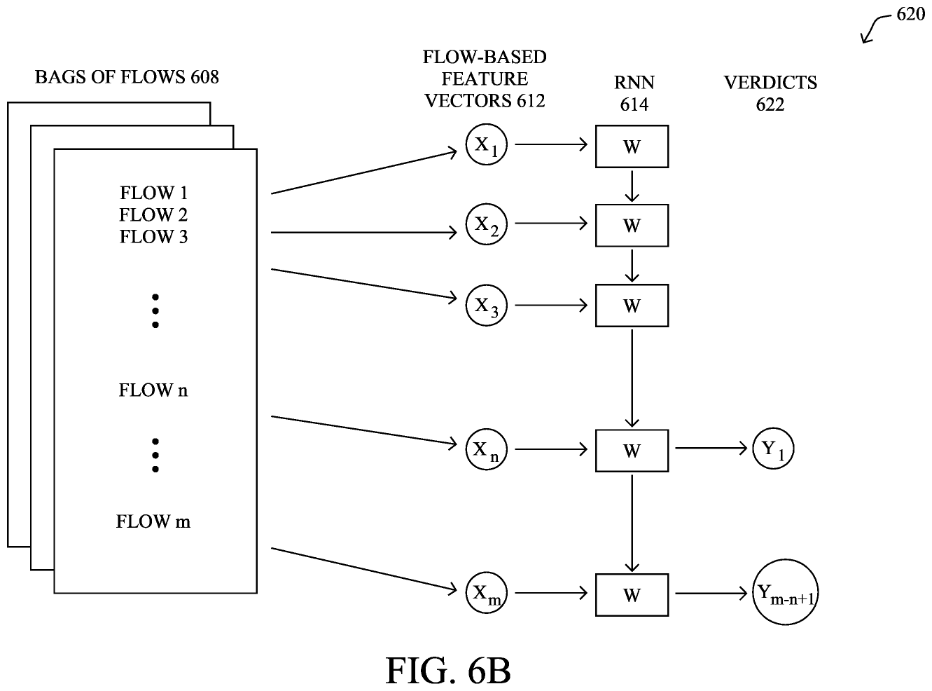

In further embodiments, FIGS. 6A-6B illustrate an example architecture for using a recurrent neural network to detect malware from patterns of encrypted traffic, according to various embodiments. The primary goal of the techniques herein is to detect signs of malware within encrypted network traffic. However, since the communications are encrypted, traditional flow-based (or packet/session/transmission-based) approaches used in existing approaches cannot be used because most of these features are not available in the captured telemetry. Accordingly, the techniques herein also introduces a bag-based approach that leverages a recurrent neural network (RNN) to perform the comparison between the patterns of encrypted traffic associated with malware and patterns of encrypted traffic observed for an endpoint device (or user).

FIG. 6A illustrates the overall architecture 600 for using an RNN to classify captured telemetry data regarding encrypted network traffic. As shown, assume that an encrypted traffic analytics (ETA) sensor 604 is present along the path through which network traffic 602 flows. During operation, a flow collector 606 may utilize ETA sensor 604 to capture telemetry data regarding the encrypted network traffic 602 that flows through the device/ETA service. As described above, such telemetry data may include the TLS features of traffic 602 (e.g., cipersuite, version, etc.), as well as flow-level details, such as size or timing information

According to various embodiments, flow collector 606 may form bags 608 of ETA flows, such as bags 608a-608c shown, using a bagging approach. In one embodiment, each bag 608 may include only flow information for the same device and autonomous system. In another embodiment, each bag 608 may group flows based on server IP address. Preferably, the size of each bag 608 using the techniques herein (i.e., the number of flows in a given bag) is not predefined, nor fixed, so that valuable information is not truncated.

Once the flows have been grouped into bags 608, flow-based feature extractor 610 may then extract out further telemetry features of the captured flows and form flow-based feature vectors 612, in various embodiments. For example, a flow-based feature vector 612 for a given bag of flows may indicate the number of bytes sent by the client/endpoint device, bytes sent by the server, average packet sizes of packets sent by the client/endpoint device, server average packet size, elapsed time, a measure of the popularity of a domain visited by the endpoint device, etc.

Once the flow-based feature vectors 612 are formed, the feature vectors 612 can be used as input to an RNN classifier 614 configured to determine whether an endpoint device is infected with malware and output an indication 616 of the infected devices. In other words, even if the endpoint devices do not host anti-virus/security agents locally, analysis of their encrypted traffic behavior can still help to determine whether the endpoint devices are infected with malware.

FIG. 6B illustrates an example of the neural network architecture 620 in greater detail, according to various embodiments. As shown, encrypted traffic flows captured by the encrypted traffic analytics service can be bagged by the service into bags 608 of flows, based on their associated endpoint devices, server IPs, or the like. In turn, for each bag 608, the encrypted traffic analytics service may extract out a number of flow-based feature vectors 612 for input to RNN 614. In some embodiments, the encrypted traffic analytics service may first build an internal, high-level representation from the first n-number of flows in a bag 608 and, based on this representation, continuously output verdicts 622 as to whether or not the encrypted traffic patterns. In other words, the verdicts 622 can potentially change over time, as more encrypted traffic is captured and analyzed by the service.

In comparison to other approaches, the proposed neural network architecture 620 requires multiple feature vectors 612 as input to RNN 614, to create a verdict 622. In addition, the size of the bag 608 is not fixed. First, the proposed architecture 620 normalizes all input values across all features. Then, the feature vectors 612 from each bag 608 are iteratively fed into RNN 614 with long short-term memory (LSTM) units and, after a predefined number of iterations, verdicts 622 are outputted. The inner network parameters of RNN 614 are learned during training and training can be achieved as described above using the patterns of encrypted traffic associated with malware detections by endpoint-executed security agents.

Pseudocode for the proposed analysis of the encrypted network traffic is as follows, in some embodiments:

```
  1. // Find malicious bags (e.g., infected devices) from the specified time window
  2. function getMaliciousBagsFromTimeWindow(FlowsInTimeWindow){
  3. // Categorize flows to bags using a combination of userID and autonomous
  system
  4. for (flow in FlowsInTimeWindow){
  5. bag = bags.get(flowAutonomousSystem, flowUserID)
  6. bag.add(flow.featureVector) //add ETA flow-feature vector to the
  corresponding bag
  7. }
  8.
  9. bags.removeSmallerThan(n) // remove bags that are too small
10.
11. for (bag in bags){
12. if (isMalicious(bag)){
13. maliciousBags.add(bag)
14. }
15. }
16. return maliciousBags
17. }
18.
19. function isMalicious(bag){
20. for (flowVector in bag){
21. RNN.push(flowVector)
22. }
23. return RNN.lastPrediction // return only last (most relevant) output of RNN
24. }
```

Thus, the proposed bag-based approach provides more information and ensures higher efficacy when compared to flow-based approaches. In addition, high-level, complex features are trained from the input data, automatically, using the proposed approach.

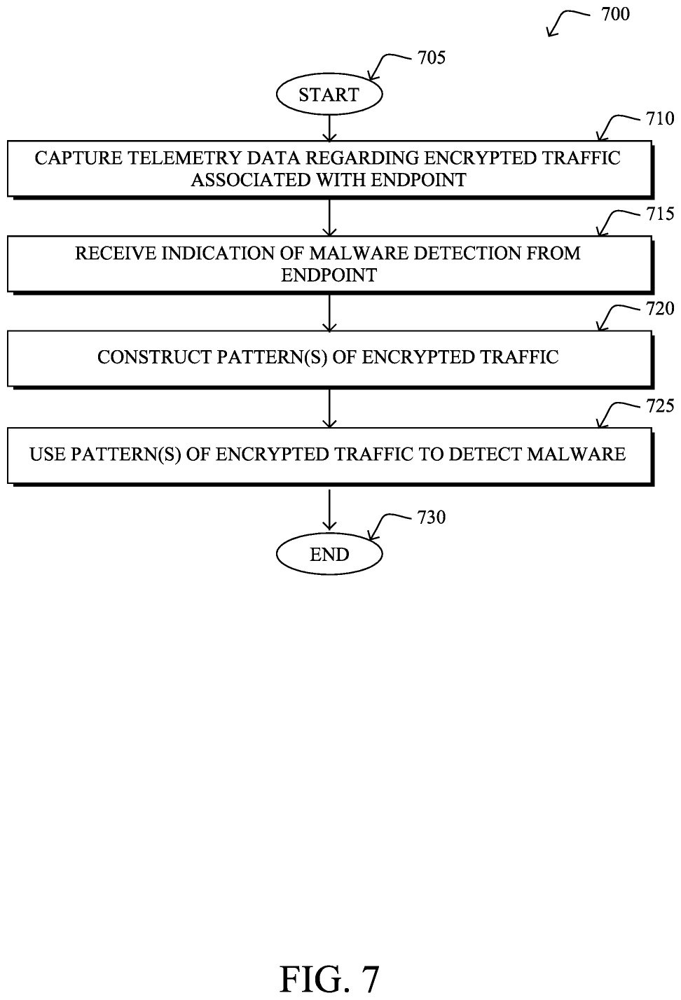

FIG. 7 illustrates an example simplified procedure for using patterns of encrypted traffic to detect malware in a network, in accordance with one or more embodiments described herein. For example, a non-generic, specifically configured device (e.g., device 200) may perform procedure 700 by executing stored instructions (e.g., process 248), to provide an encrypted traffic analytics service in the network. The procedure 700 may start at step 705, and continues to step 710, where, as described in greater detail above, the service captures telemetry data regarding encrypted network traffic associated with a first endpoint device in a network. Such telemetry data may include, but is not limited to, a Transport Layer Security (TLS) extension, a cipher suite, a TLS version, or sequence of packet lengths and time (SPLT) information for the encrypted network traffic. In cases in which the service uses a bag-based approach to analyze the encrypted traffic, the telemetry data may also include a number of traffic bytes, an average packet size, or a measure of popularity of a domain with which the second endpoint device communicated.

At step 715, as detailed above, the service may receive, from the first endpoint device, an indication that a security agent executed on the first endpoint device has detected malware on the first endpoint device. For example, the first endpoint device may execute an anti-malware/anti-virus/security agent that is configured to detect malicious binaries on the first endpoint device. In turn, the service can use the indication of malware detection to associate encrypted traffic of the endpoint device to the malicious binary.

At step 720, the service may construct one or more patterns of encrypted traffic using the captured telemetry data from a time period associated with the received indication, as described in greater detail above. In some embodiments, the service may use a bag-based approach whereby encrypted traffic flows are grouped into ‘bags’ and, for a given bag, feature vectors of flow-based features extracted therefrom.

At step 725, as detailed above, the service may use the one or more patterns of encrypted traffic to detect malware on a second endpoint device by comparing the one or more patterns of encrypted traffic to telemetry data regarding encrypted network traffic associated with the second endpoint device. For example, if a bag-based approach is used, the service may train an RNN or other machine learning model using the feature vectors from the first endpoint device to determine whether the encrypted traffic of another endpoint device, such as the second endpoint device, is indicative of that other endpoint device being infected with malware. Doing so allows for the detection of malware on the second endpoint device, even if the second endpoint device does not execute a security agent locally. If malware is detected on the second endpoint device, the service may then initiate a mitigation action, such as sending an alert to a user interface and/or blocking traffic associated with the second endpoint device. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore allow for the online cooperation between network and endpoint security mechanisms. In addition, this protection can be extended to the whole network (e.g., to endpoints lacking an endpoint security agent), using the techniques herein. Further, the techniques herein also provide nearly instantaneous protection through the capture and promulgation of encrypted traffic patterns, which can be used to detect the presence of malware without requiring decryption of the traffic.

While there have been shown and described illustrative embodiments that provide for dynamically tracking/modeling systems according to risk level, it is to be understood that various other adaptations and modifications may be made within the spirit and scope of the embodiments herein. For example, while certain embodiments are described herein with respect to using certain models for purposes of malware detection, the models are not limited as such and may be used for other functions, in other embodiments. In addition, while certain protocols are shown, such as TLS, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
capturing, by an encrypted traffic analytics service, telemetry data regarding encrypted network traffic associated with a first endpoint device in a network;
receiving, at the encrypted traffic analytics service and from the first endpoint device, an indication that a security agent executed on the first endpoint device has detected malware on the first endpoint device;
constructing, by the encrypted traffic analytics service, one or more patterns of encrypted traffic using the captured telemetry data from a time period associated with the received indication; and
using, by the encrypted traffic analytics service, the one or more patterns of encrypted traffic to detect malware on a second endpoint device by comparing the one or more patterns of encrypted traffic to telemetry data regarding encrypted network traffic associated with the second endpoint device.

2. The method as in claim 1, further comprising:
initiating, by the encrypted traffic analytics service, a mitigation action after detecting malware on the second endpoint device, wherein the mitigation action comprises sending a malware detection alert to a user interface or blocking network traffic associated with the second endpoint device.

3. The method as in claim 1, wherein the second endpoint device does not execute a security agent configured to detect malware.

4. The method as in claim 1, wherein the telemetry data comprises one or more of: a Transport Layer Security (TLS) extension, a cipher suite, a TLS version, or sequence of packet lengths and time (SPLT) information for the encrypted network traffic.

5. The method as in claim 1, wherein the telemetry data regarding the encrypted network traffic associated with the second endpoint device comprises one or more flow-based traffic features, and wherein using the one or more patterns of encrypted traffic to detect malware comprises:
forming bags of traffic flows of the encrypted network traffic associated with the second endpoint device;
constructing flow-based feature vectors from the flow-based traffic features associated with the bags of traffic flows; and
using the flow-based feature vectors as input to a recurrent neural network (RNN) trained to detect malware-generated encrypted network traffic.

6. The method as in claim 5, wherein the bags of traffic flows comprise different numbers of traffic flows.

7. The method as in claim 5, wherein the flow-based traffic features comprise at least one of: a number of traffic bytes, an average packet size, or a measure of popularity of a domain with which the second endpoint device communicated.

8. An apparatus, comprising:
one or more network interfaces to communicate with a zero trust network;
a processor coupled to the network interfaces and configured to execute one or more processes; and
a memory configured to store a process executable by the processor, the process when executed configured to:
capture telemetry data regarding encrypted network traffic associated with a first endpoint device in a network;
receive, from the first endpoint device, an indication that a security agent executed on the first endpoint device has detected malware on the first endpoint device;
construct one or more patterns of encrypted traffic using the captured telemetry data from a time period associated with the received indication; and
use the one or more patterns of encrypted traffic to detect malware on a second endpoint device by comparing the one or more patterns of encrypted traffic to telemetry data regarding encrypted network traffic associated with the second endpoint device.

9. The apparatus as in claim 8, wherein the process when executed is further configured to:
initiate a mitigation action after detecting malware on the second endpoint device, wherein the mitigation action comprises sending a malware detection alert to a user interface or blocking network traffic associated with the second endpoint device.

10. The apparatus as in claim 8, wherein the second endpoint device does not execute a security agent configured to detect malware.

11. The apparatus as in claim 8, wherein the telemetry data comprises one or more of: a Transport Layer Security (TLS) extension, a cipher suite, a TLS version, or sequence of packet lengths and time (SPLT) information for the encrypted network traffic.

12. The apparatus as in claim 8, wherein the telemetry data regarding the encrypted network traffic associated with the second endpoint device comprises one or more flow-based traffic features, and wherein the apparatus uses the one or more patterns of encrypted traffic to detect malware by:
forming bags of traffic flows of the encrypted network traffic associated with the second endpoint device;
constructing flow-based feature vectors from the flow-based traffic features associated with the bags of traffic flows; and
using the flow-based feature vectors as input to a recurrent neural network (RNN) trained to detect malware-generated encrypted network traffic.

13. The apparatus as in claim 12, wherein the bags of traffic flows comprise different numbers of traffic flows.

14. The apparatus as in claim 12, wherein the flow-based traffic features comprise at least one of: a number of traffic bytes, an average packet size, or a measure of popularity of a domain with which the second endpoint device communicated.

15. A tangible, non-transitory, computer-readable medium storing program instructions that cause an encrypted traffic analytics service to execute a process comprising:
capturing, by the encrypted traffic analytics service, telemetry data regarding encrypted network traffic associated with a first endpoint device in a network;
receiving, at the encrypted traffic analytics service and from the first endpoint device, an indication that a security agent executed on the first endpoint device has detected malware on the first endpoint device;
constructing, by the encrypted traffic analytics service, one or more patterns of encrypted traffic using the captured telemetry data from a time period associated with the received indication; and
using, by the encrypted traffic analytics service, the one or more patterns of encrypted traffic to detect malware on a second endpoint device by comparing the one or more patterns of encrypted traffic to telemetry data regarding encrypted network traffic associated with the second endpoint device.

16. The computer-readable medium as in claim 15, wherein the process further comprises:
initiating, by the encrypted traffic analytics service, a mitigation action after detecting malware on the second endpoint device, wherein the mitigation action comprises sending a malware detection alert to a user interface or blocking network traffic associated with the second endpoint device.

17. The computer-readable medium as in claim 15, wherein the second endpoint device does not execute a security agent configured to detect malware.

18. The computer-readable medium as in claim 15, wherein the telemetry data comprises one or more of: a Transport Layer Security (TLS) extension, a cipher suite, a TLS version, or sequence of packet lengths and time (SPLT) information for the encrypted network traffic.

19. The computer-readable medium as in claim 15, wherein the telemetry data regarding the encrypted network traffic associated with the second endpoint device comprises one or more flow-based traffic features, and wherein using the one or more patterns of encrypted traffic to detect malware comprises:
forming bags of traffic flows of the encrypted network traffic associated with the second endpoint device;
constructing flow-based feature vectors from the flow-based traffic features associated with the bags of traffic flows; and
using the flow-based feature vectors as input to a recurrent neural network (RNN) trained to detect malware-generated encrypted network traffic.

20. The computer-readable medium as in claim 19, wherein the encrypted network traffic associated with the second endpoint device is not decrypted by the encrypted traffic analytics service.
